(19) United States
(12) Patent Application Publication
(10) Pub. No.: US 2019/0156291 A1
(43) Pub. Date: May 23, 2019

(54) SYSTEMS AND METHODS FOR COMPUTER- ASSISTED EVALUATION AND SCORING

(71) Applicant: Vetty, Inc., New York, NY (US)

(72) Inventors: Subrat Nayak, Jersey City, NJ (US); Bejoy John, Bronx, NY (US)

(21) Appl. No.: 16/196,491

(22) Filed: Nov. 20, 2018

Related U.S. Application Data
(60) Provisional application No. 62/588,726, filed on Nov. 20, 2017.
(60) Provisional application No. 62/609,773, filed on Dec. 22, 2017.
(60) Provisional application No. 62/692,637, filed on Jun. 29, 2018.

(51) Int. Cl. G06Q 10/10; G06Q 10/06; H04L 29/08; G06F 16/9535; H04L 29/06; H04L 9/06

(52) U.S. Cl. CPC G06Q 10/1053; G06Q 10/0635; H04L 67/306; G06Q 50/01; H04L 63/10; H04L 9/0637; G06F 16/9535

(57) ABSTRACT

Systems and methods for computer-aided candidate evaluation using artificial intelligence to provide real time scoring, verification and evaluation. A server connected to a plurality of data sources and one or more end-user devices over a telecommunications network in a client-server architecture conducts identity verification, background checks, and examines credentials and qualifications.

### CROSS-REFERENCE TO RELATED APPLICATIONS

This application claims benefit of U.S. Prov. Pat. App. Ser. No. 62/588,726, filed Nov. 20, 2017, and U.S. Prov. Pat. App. Ser. No. 62/609,773, filed Dec. 22, 2017, and U.S. Prov. Pat. App. Ser. No. 62/692,637, filed Jun. 29, 2018. The entire disclose of all of these documents is incorporated herein by reference.

### BACKGROUND OF THE INVENTION

### Field of the Invention

This disclosure is related to the field of candidate scoring, and more particularly to the use of artificial-intelligence to analyze the risk level posed by a candidate or applicant for a particular role in an organization.

### Description of the Related Art

Many industries and businesses perform background checks on candidates for employment, especially if the position involves access to sensitive information, materials, or equipment or is a position of trust. Jobs in schools, hospitals, airports, and government, for example often require a level of confidence and trust in the judgment of employees. Background checks are intended to determine whether a new hire candidate may compromise the organization, its customers or assets. These checks may be administered by a public agency or by private companies.

Background checks typically include information about past employment, credit, and criminal history, revealing past mistakes or reasons to question the character or fitness of a candidate. The objective of background checks is to ensure the safety and security of the employees in the organization

The most basic background checks merely confirm information provided by the candidate such as data provided on an employment application or résumé, such as prior employment positions and dates, academic credentials, and confirming identity. Checks may also identify gaps in employment or educational history, or irregularities in address history. Some checks may include contacting character references.

The type, nature and quantity of information presented on a background check varies with the specific reason for the check in the first place. For example, a line cook would ordinarily be subject to less scrutiny than a law enforcement applicant, or a position working with children or the elderly.

Background checks, while useful, generally rely on incomplete data and take a long time to complete. It is not uncommon for a basic background check to require several weeks or more to be completed.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a method for securely and privately sharing confidential information comprising: providing a server computer communicably coupled to a plurality of data sources and communicably coupled to an end-user user device via a telecommunications network, the server computer being a node on a blockchain; receiving profile information about at least one prospective candidate for employment; receiving, from at least one of the plurality of data sources, background check information about the at least one prospective candidate; creating on the blockchain an encrypted candidate profile for the at least one prospective candidate, the candidate profile comprising at least one smart contract associated with at least some of the background check information, the at least one smart contract having at least one conditional for decrypted access to the at least some of the background check information; at the computer server, satisfying the at least one condition and receiving decrypted access to the at least some background check information; and displaying, on an end-user device, a profile summary of the prospective candidate, the profile summary based at least in part on the decrypted at least some background check information.

In an embodiment of the method, each data source in the plurality of data sources is selected from the group consisting of: a sex offender registry; a global sanction list; a terrorist watch list; a criminal record database; a driving record database; a drug testing database; a bankruptcy database; and a judgement and lien database.

In a further embodiment of the method, the criminal record database is selected from the group consisting of: an international criminal record database; a national criminal record database; a state criminal record database; and a county criminal record database.

In another embodiment of the method, the receiving profile information is received from the prospective candidate.

In still another embodiment of the method, the background check information is received at the server.

In still another embodiment of the method, the encrypted candidate profile is encrypted using asymmetric encryption.

In still another embodiment of the method, the at least some background check information is selected from the group consisting of: identification verification data; education verification data; employment verification data; reference check data; license verification data; certification verification data; insurance data; sex offender registry data; global sanction data; terrorist watch data; criminal record data; driving record data; drug testing data; bankruptcy data; and judgement and lien data.

In still another embodiment of the method, the displayed profile summary of the prospective candidate comprises a visual representation of a timeline of a plurality of tasks in an employment application process.

In still another embodiment of the method, the at least one condition comprises receiving an indication that the prospective candidate consents to a background check.

In still another embodiment of the method, the method further comprises: at the computer server, one or more intelligent agents of the server computer analyzing the received profile information, the analysis comprising: receiving from at least one of the plurality of data sources verification data associated with the prospective candidate; comparing the received profile information to the received verification data; and based upon the results of the comparing, determining whether the received profile information is accurate.

In a further embodiment of the method, the method further comprises: in the determining, the determined accuracy of the profile information being determined based at least in part on training data received from a user.

In another embodiment of the method, the analyzing is unsupervised.

In still another embodiment of the method, the analyzing is supervised.

In still another embodiment of the method the displayed profile summary comprises a visual indication of the results of the analyzing.

In still another embodiment of the method, the displayed profile summary does not provide an indication of the decrypted at least some background check information.

In still another embodiment of the method, the displayed profile summary includes a calculated score for the at least one prospective candidate.

In still another embodiment of the method, the calculated score is calculated at least in part based on the at least some background check information.

In still another embodiment of the method, the calculated score is calculated based at least in part on the results of the analyzing.

In still another embodiment of the method, the at least some background check information comprises social media content associated with the at least one prospective candidate.

In still another embodiment of the method, the calculated score is calculated at least in part based on the social media content.

### BRIEF DESCRIPTION OF THE DRAWINGS

FIG. 1 depicts a schematic diagram embodiment of a system and method according to this disclosure.

FIGS. 2A-2B depicts an embodiment of a timeline user interface according to this disclosure.

FIGS. 3A-3B depicts an embodiment of a report interface according to this disclosure.

FIG. 4 depicts an embodiment of a dashboard interface according to this disclosure.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Throughout this disclosure, the term “computer” describes hardware that generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wrist wear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices that are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

As will be appreciated by one skilled in the art, some aspects of the present disclosure may be embodied as a system, method or process, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Program code embodied on a computer readable medium may be transmitted using any appropriate medium, including but not limited to wireless, wireline, optical fiber cable, RF, etc., or any suitable combination of the foregoing.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the term “cloud” and “cloud computing” and similar terms refers to the practice of using a network of remote servers hosted and accessed over the Internet to store, manage, and process data, rather than local servers or personal computers.

Throughout this disclosure, the terms “web,” “web site,” “web server,” “web client,” and “web browser” refer generally to computers programmed to communicate over a network using the HyperText Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

Throughout this disclosure, the term “real time” refers to software operating within operational deadlines for a given event to commence or complete, or for a given module, software, or system to respond, and generally invokes that the response or performance time is, in ordinary user perception and considered the technological context, effectively generally contemporaneous with a reference event. Those of ordinary skill in the art understand that “real time” does not literally mean the system processes input and/or responds instantaneously, but rather that the system processes and/or responds rapidly enough that the processing or response time is within the general human perception of the passage of real time in the operational context of the program. Those of ordinary skill in the art understand that, where the operational context is a graphical user interface, “real time” normally implies a response time of no more than one second of actual time, with milliseconds or microseconds being preferable. However, those of ordinary skill in the art also understand that, under other operational contexts, a system operating in “real time” may exhibit delays longer than one second, particularly where network operations are involved.

Throughout this disclosure, the term “GUI” generally refers to a graphical user interface for a computing device. The design, arrangement, components, and functions of a graphical user interface will necessarily vary from device to device depending on, among other things, screen resolution, processing power, operating system, device function or purpose, and evolving standards and tools for user interface design. One of ordinary skill in the art will understand that graphical user interfaces generally include a number of widgets, or graphical control elements, which are generally graphical components displayed or presented to the user and which are manipulable by the user through an input device to provide user input, and which may also display or present to the user information, data, or output.

For purposes of this disclosure, there will also be significant discussion of a special type of computer referred to as a “mobile communication device” or simply “mobile device”. A mobile communication device may be, but is not limited to: a smart phone, tablet PC, e-reader, satellite navigation system (“SatNav”), fitness device (e.g. a Fitbit™ or Jawbone™) or any other type of mobile computer whether of general or specific purpose functionality. Generally speaking, a mobile communication device is network-enabled and communicating with a server system providing services over a telecommunication or other infrastructure network. A mobile communication device is essentially a mobile computer, but one which is commonly not associated with any particular location, is also commonly carried on a user's person, and usually is in near-constant real-time communication with a network.

As used herein, the term “blockchain” means a distributed database system comprising a continuously-growing list of ordered records (“blocks”) shared across a network. In a typical embodiment, the blockchain functions as a shared transaction ledger. Similarly, as used herein, the term “blockchain network” means the collection of nodes interacting via a particular blockchain protocol and rule set. These and other definitions used in describing blockchain technologies may be further understood in the context of leading white papers pertaining to the subject matter which include, but are not necessarily limited to, Bitcoin: A Peer-to-Peer Electronic Cash System (Satoshi Nakamoto 2008). It will be understood by a person of ordinary skill in the art that the precise vocabulary of blockchains continues to evolve, and although the industry has established a general shared understanding of the meaning of the terms, variations exist. The present disclosure contemplates the use of a blockchain network that implements “smart contracts.” As used herein, “smart contracts” means computer programs executed by a computer system that facilitate, verify, or enforce the negotiation and performance of an agreement using computer language rather than legal terminology. In the context of a blockchain, the blockchain smart contracts are executed and verified on virtual computer systems distributed across a blockchain. An example of such a blockchain network is Ethereum.

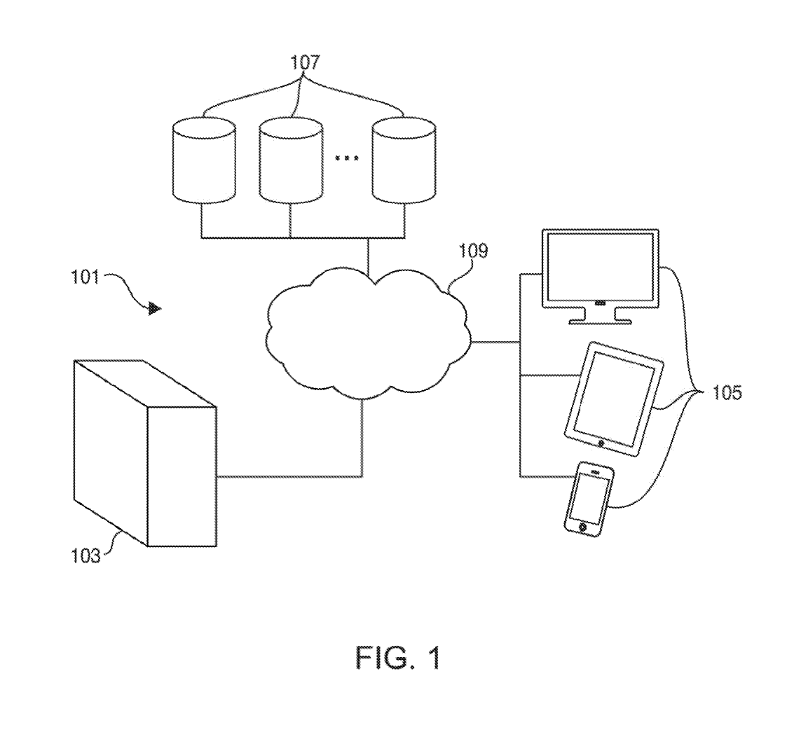

Described herein, among other things, are systems and methods for evaluating candidates using artificial intelligence to provide real time scoring, verification and evaluation. FIG. 1 depicts a schematic view of the systems and methods described herein. In the depicted embodiment of FIG. 1, the system (101) comprises a server system (103) connected to a plurality of data sources (107) and one or more end-user devices (105). These connections are via a telecommunications network (109) in a client-server architecture. At a high level, the systems and methods provide three primary functions: (1) identity verification; (2) background checks; and (3) credentials and qualifications.

In an embodiment, a user to be validated or verified submits information and a consent via a GUI. The GUI is generally displayed via a web browser on a candidate's end user device (105), and communicates with the server (103) for presenting and receiving the input from the GUI. Information requested may include full name, social security number, and other such information. Next, the information received from the candidate is provided to evaluation software running on the server (103). This eliminates the need for a human to view the candidate's information. Algorithms, as described elsewhere herein, apply data analytics to the received information and perform the necessary tasks (evaluation, verification, etc.). Next, the results of these tasks are provided to a decision maker, usually a hiring manager or human resources person.

For background checks, this method may be used with any number of data sources (107), such as, without limitation: sex offender registries; global sanctions and terrorist watch lists; national criminal record databases; county criminal record databases; federal criminal record databases; state criminal record databases; driving record databases; drug testing databases; international background databases; bankruptcy databases; and judgement and lien databases. For credentials and qualifications, the method may validate or evaluate, without limitation: educational credentials or history; employment credentials or history; reference checks; professional or other licensing verification; certification verification; liability insurance verification; bonding requirements; and workmen's compensation insurance.

The depicted system uses multiple sources (107) to provide more complete information than any one source. Additionally, machine-learning algorithms examine the data (107), and feedback from end users, to determine which sources (107) provide the most useful analytics. Because the process is conducted automatically, results are typically provided in real time. In an embodiment, the server (103) may be integrated with a third party human resources computer software system. This may be done via an application programming interface or software development kit.

In an embodiment, the server (103) comprises one or more “bots,” also known in the art as software agents or intelligent agents, which conduct continuous evaluation of data sources (107).

In an embodiment, a blockchain network may be used to create and share profiles. For example, and without limitation, in one embodiment, the Ethereum blockchain system may be used to effectively form a private blockchain network in which smart contracts are used to create and share profiles generated by the systems and methods described above. The method of making such a system will be clear to person of ordinary skill the art. By way of example and not limitation, this aspect may be implemented using ordinary programming techniques in the Solidity and Python programming language.

Blockchain networks effectively uses contracts, to varying degrees of sophistication and complexity, to store various blocks of information, in a ledger. It is contemplated herein that some or all of the information about the subject of a report may be stored or saved via a smart contract on a blockchain network. Such information may be any data about the user which is desired to be shared (e.g., with a potential employer), such as, but not necessarily limited to: social security number check and identification verification; sex offender registry; global sanctions and terrorist watch-list, national criminal record check, county criminal record check, federal criminal record check, state criminal record check, driving record check, drug tests, international background checks, bankruptcies, judgments and liens, education verification, employment verification, reference checks, license verification, certification verification, liability insurance verification, workers compensation insurance verification; and, any other background check information.

In one embodiment, each type of background check information may be saved in its own smart contract type. Alternatively, multiple types of information may be stored together, particularly where they are functionally similar. Users may then share some or all of the ledger data about themselves with others by simply providing the key to the person with whom they wish to share the data.

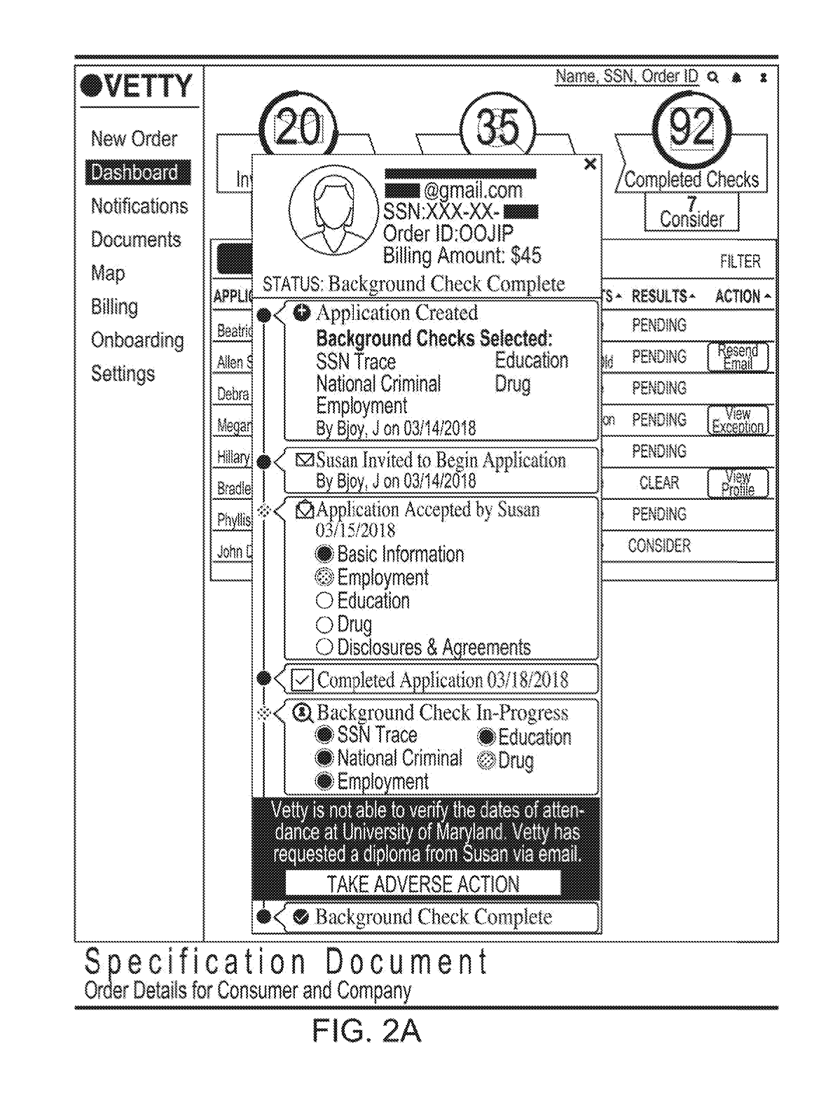

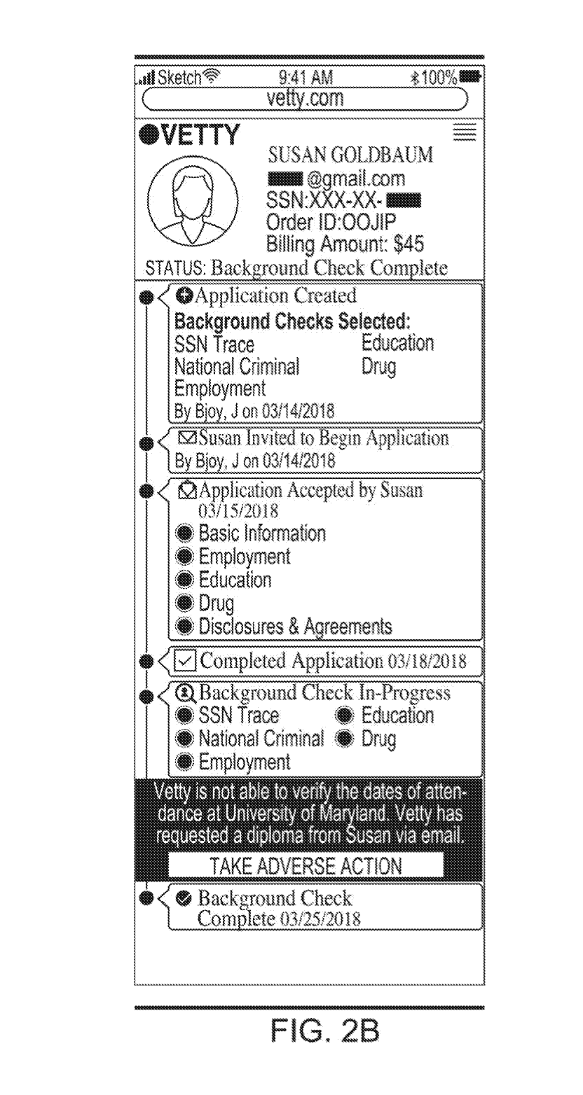

FIGS. 2A-2B depicts an embodiment of a user interface according to the present disclosure, specifically, a background check timeline. The depicted embodiment of a timeline conveys the real-time status of various stages of an applicant profile, including completed and upcoming tasks. This may include all or some actions taken by the system, a user, or a subject in real-time. This information may be available to all or only some users, and may be shared with third parties, such as by publication via a blockchain system or other public ledger.

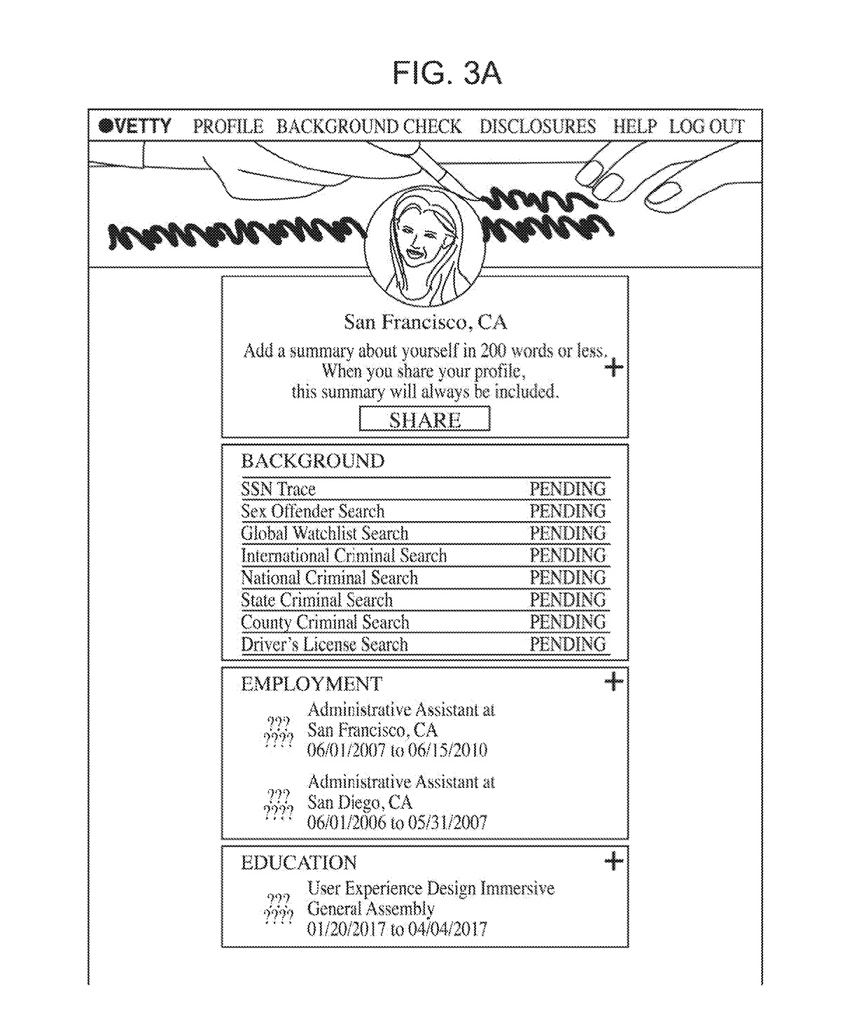

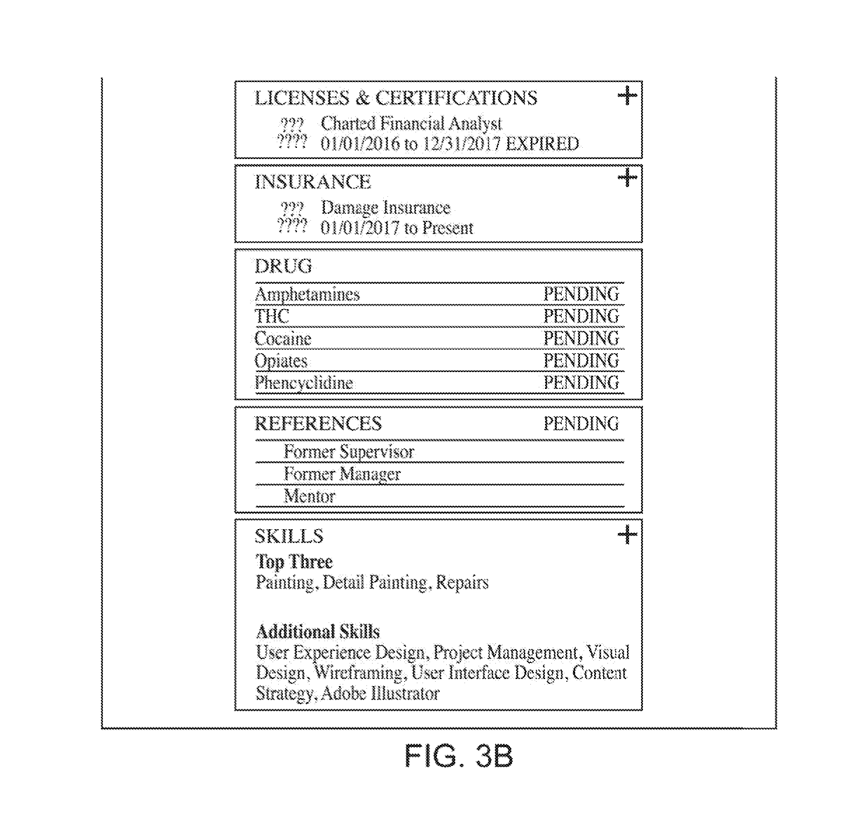

FIGS. 3A-3B depicts an embodiment a report interface according to the present disclosure. The depicted user interface is aesthetically similar to a conventional social media profile and includes all available elements of the background check, such as, but not necessarily limited to, employment history, verified background check information, verified license details, and so forth. The underlying data and/or this specific interface may be shared with third parties. This report is updated in real time by the back end of the system.

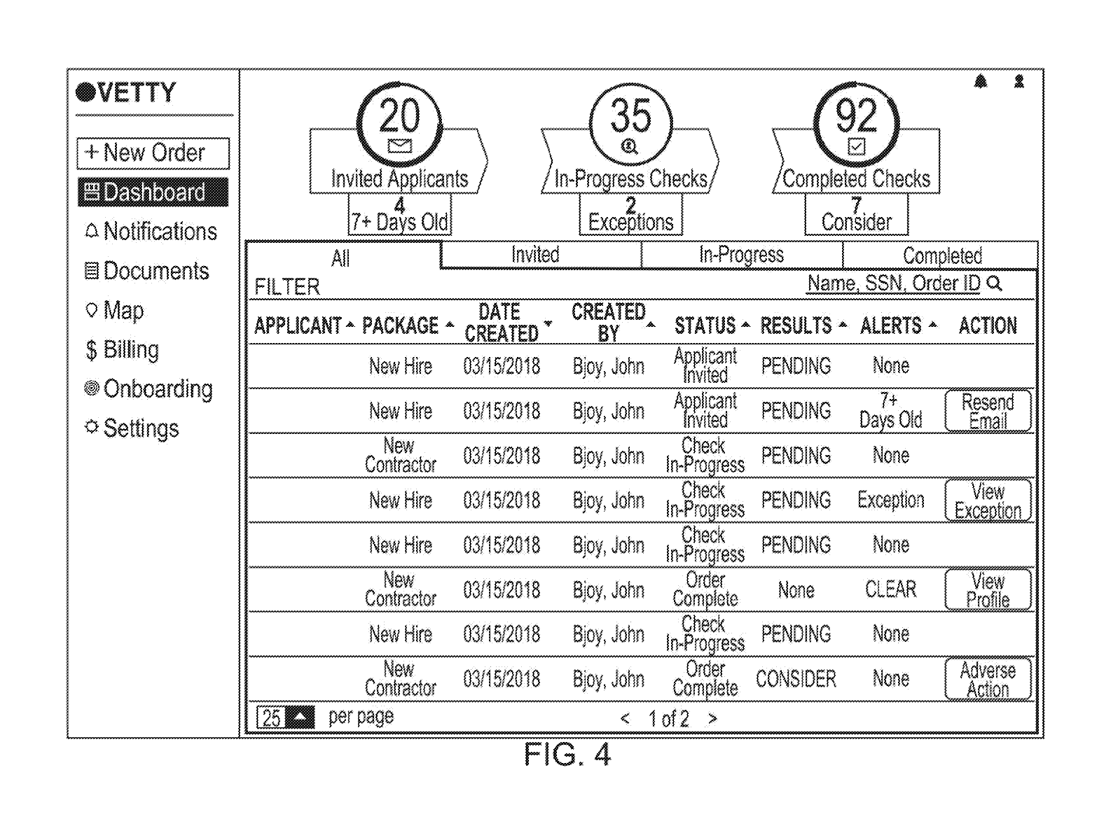

FIG. 4 depicts an embodiment of a dashboard interface according to the present disclosure. The depicted dashboard comprises a real-time dashboard to highlight the status of various applicants. The depicted dashboard includes a high level overview as well as a detailed view for the various stages of the background check. The page is updated in real-time using web sockets and other networking technologies. Users may manipulate the interface elements to analyze data further. By way of example and not limitation, a mapping feature may be included or integrated with the interface using a mapping system to perform a geographical analysis.

In an embodiment, the candidate scoring uses a candidate's background information, including, but not necessarily limited to: criminal history; education; employment history; license history; credential history; and, reference checks, to analyze the risk level presented by the candidate or applicant. In an embodiment, name matching comprises the use of an algorithm to match a provided name to data indicative of a specific individual based on the applicant's provided data of birth, geographic location or residence, as well as information acquired from social media sites. In an embodiment, the systems and methods use artificial intelligence based compliance to automate certain legal compliance tasks, such as Fair Credit Reporting Act and state credit reporting act rules. In an embodiment, quality assurance is facilitated by artificial intelligence, such as, without limitation, assembling background check reports and completing quality assurance of the report using intelligent agents.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A method for securely and privately sharing confidential information comprising:
providing a server computer communicably coupled to a plurality of data sources and communicably coupled to an end-user user device via a telecommunications network, said server computer being a node on a blockchain;
receiving profile information about at least one prospective candidate for employment;
receiving, from at least one of said plurality of data sources, background check information about said at least one prospective candidate;
creating on said blockchain an encrypted candidate profile for said at least one prospective candidate, said candidate profile comprising at least one smart contract associated with at least some of said background check information, said at least one smart contract having at least one conditional for decrypted access to said at least some of said background check information;
at said computer server, satisfying said at least one condition and receiving decrypted access to said at least some background check information; and
displaying, on an end-user device, a profile summary of said prospective candidate, said profile summary based at least in part on said decrypted at least some background check information.

2. The method of claim 1, wherein each data source in said plurality of data sources is selected from the group consisting of: a sex offender registry; a global sanction list; a terrorist watch list; a criminal record database; a driving record database; a drug testing database; a bankruptcy database; and a judgement and lien database.

3. The method of claim 2, wherein said criminal record database is selected from the group consisting of: an international criminal record database; a national criminal record database; a state criminal record database; and a county criminal record database.

4. The method of claim 1, wherein said receiving profile information is received from said prospective candidate.

5. The method of claim 1, wherein said background check information is received at said server.

6. The method of claim 1, wherein said encrypted candidate profile is encrypted using asymmetric encryption.

7. The method of claim 1, wherein said at least some background check information is selected from the group consisting of: identification verification data; education verification data; employment verification data; reference check data; license verification data; certification verification data; insurance data; sex offender registry data; global sanction data; terrorist watch data; criminal record data; driving record data; drug testing data; bankruptcy data; and judgement and lien data.

8. The method of claim 1, wherein said displayed profile summary of said prospective candidate comprises a visual representation of a timeline of a plurality of tasks in an employment application process.

9. The method of claim 1, wherein said at least one condition comprises receiving an indication that said prospective candidate consents to a background check.

10. The method of claim 1, further comprising:
at said computer server, one or more intelligent agents of said server computer analyzing said received profile information, said analysis comprising:
receiving from at least one of said plurality of data sources verification data associated with said prospective candidate;
comparing said received profile information to said received verification data; and
based upon the results of said comparing, determining whether said received profile information is accurate.

11. The method of claim 10, further comprising:
in said determining, said determined accuracy of said profile information being determined based at least in part on training data received from a user.

12. The method of claim 10, wherein said analyzing is unsupervised.

13. The method of claim 10, wherein said analyzing is supervised.

14. The method of claim 10, wherein said displayed profile summary comprises a visual indication of the results of said analyzing.

15. The method of claim 14, wherein said displayed profile summary does not provide an indication of said decrypted at least some background check information.

16. The method of claim 15, wherein said displayed profile summary includes a calculated score for said at least one prospective candidate.

17. The method of claim 16, wherein said calculated score is calculated at least in part based on said at least some background check information.

18. The method of claim 16, wherein said calculated score is calculated based at least in part on the results of said analyzing.

19. The method of claim 16, wherein said at least some background check information comprises social media content associated with said at least one prospective candidate.

20. The method of claim 19, wherein said calculated score is calculated at least in part based on said social media content.
